(19) United States
(12) Patent Application Publication
(10) Pub. No.: US 2025/0231070 A1
(43) Pub. Date: Jul. 17, 2025

(54) Conduit connection device

(71) Applicant: NORMA GERMANY GMBH, Maintal (DE)

(72) Inventors: Brian Thomas IGNACZAK, Maintal (DE); David PETERSON, Maintal (DE); Jiri ZUKAL, Maintal (DE); Viktor STOLL, Maintal (DE)

(21) Appl. No.: 18/703,703

(22) PCT Filed: Oct. 19, 2022
(86) PCT No.: PCT/EP2022/079133

§ 371 Date: Apr. 22, 2024

(30) Foreign Application Priority Data
Oct. 21, 2021 (DE) 10 2021 127 433.8

(51) Int. Cl. G01K 1/16; G01K 13/02

(52) U.S. Cl. CPC G01K 1/16; G01K 13/02; F16L 2201/00

(57) ABSTRACT

A conduit connection device is described, comprising a housing, which has a connection geometry for connection of a conduit element which is connected to the conduit connection device to a counterpart conduit element, a hollow pipe section for transporting a fluid through the conduit connection device, and a temperature sensor for measuring a temperature of the fluid to be conducted through the conduit connection device. A heat conduction element is arranged in the housing such that the fluid to be transported flows against it on an inner side of the heat conduction element. The temperature sensor is arranged on an outer side of the heat conduction element.

### INTRODUCTION

The disclosure relates to a conduit connection device. The conduit connection device has a temperature sensor.

In many technical applications, for example, in motor vehicles, it is necessary to divide fluid conduits into multiple sections and connect them to one another or to connect fluid conduits to machine components. Corresponding fluids include liquids and gases. A variety of different conduit connection devices for one or more fluid conduits are known for this purpose in the prior art.

Furthermore, it is known that process parameters in technical devices have to be complied with and therefore monitored. With respect to fluids this normally relates in particular to flow velocity, pressure, and/or temperature. It is known that conduit connection devices can be used to attach corresponding sensors. An interruption of the fluid conduits is often present in any case at conduit connection devices, so that an arrangement at such a point can save components and installation space in relation to arrangements in the middle of a line. The arrangement of temperature sensors on corresponding conduit connection devices is also known.

However, the known solutions are generally very voluminous, which makes the construction of machines that use such known conduit connection devices significantly more difficult. In many applications, insufficient installation space is available for known solutions.

Furthermore, it is known that the introduction of corresponding sensors can disrupt the fluid flow and thus reduces the flow efficiency or increases the flow resistance. In addition, it is known that in pressurized conduits in particular, the provision of openings for introducing corresponding sensors represents a risk of leakage in continuous operation.

A connector for a fluid conduit is known from DE 10 2011 102 154 A1, having a housing which has a connecting piece connectable to a pipe and a connection geometry connectable to a counterpart element. The desire is to be able to lead an auxiliary element out of a fluid conduit, wherein the risk of a leak is to be low. For this purpose, it is provided that the housing has an outlet opening, through which at least one auxiliary element is led outward out of the housing, wherein the auxiliary element is led through an elastomeric body which expands, upon an application of pressure parallel to the passage direction of the auxiliary element through the elastomeric body, perpendicular to the passage direction and which may be held by a holding device in the outlet opening. It is furthermore disclosed that a predetermined device can be arranged in the interior of the fluid conduit, wherein this device has to communicate with the outside world so that it is necessary to lead an auxiliary element, which is connected to the device or even forms this device, out of the fluid conduit. One example of such a device is a heating device. However, the device can also be a sensor, which determines, for example, pressure, temperature, flow velocity, viscosity, or the like of a medium inside the fluid conduit.

The known prior art has the disadvantage that the corresponding construction is voluminous and very complex and thus expensive.

### SUMMARY

A problem addressed, per an embodiment, is thus that of overcoming the disadvantages of the prior art and specifying a conduit connection device having a temperature sensor which is more space-saving and cost-effective, and requires lower maintenance than known conduit connection devices.

A conduit connection device is described hereinafter, per an embodiment, comprising a housing which has a connection geometry for connecting a conduit element which is connected to the conduit connection device to a counterpart conduit element, a hollow pipe section for transporting a fluid through the conduit connection device, and a temperature sensor for measuring a temperature of the fluid to be conducted through the conduit connection device, wherein a heat conduction element is arranged in the housing such that the fluid to be transported flows against it on an inner side of the heat conduction element, wherein the temperature sensor is arranged on an outer side of the heat conduction element.

The connection geometry can be selected in accordance with the respective intended use. For example, the connection geometry may have a bayonet fitting, a screw fitting, a snap fitting, an actuatable catch fitting, for example by means of a pushbutton, or the like.

Plastic is advisable in particular as the material for the housing, since plastic can be molded cost-effectively in complex shapes while complying with narrow tolerances, for example, by injection molding methods. For example, nylon variants such as PA12 or PA66 or aluminum alloys such as QC-7 are useful materials.

The housing can be or become connected, for example, to a tube or to a pipe or a corresponding connecting piece on an assembly or a component of a machine.

The provision of a heat conduction element which is in contact with the fluid on one hand and with the temperature sensor on the other hand enables the temperature sensor to be decoupled from the fluid flow. In this respect, complex sealing of the temperature sensor can often be omitted. Such a seal would moreover increase the measurement inertia, since materials which do not have good heat conduction, such as rubber or plastic, often have to be used as sealing materials.

Furthermore, by providing the corresponding heat conduction element, it is possible to prevent leaks from arising in the area of a temperature sensor used. The heat conduction element itself can be made fluid-tight in certain embodiments. The entire device can be constructed significantly more compactly by dispensing with complex seals of the connection and of the temperature sensor.

The heat conduction element can be designed so that it has good heat conductivities, in particular a low heat resistance, and a state thus results rapidly within the heat conduction element which has a clear relationship to the temperature of the fluid conducted through. The state can be an equilibrium state, in which the temperature of the heat conduction element correlates with the temperature of the fluid, possibly in consideration of further factors such as a differing outside temperature, which could possibly result in cooling or additional heating of the heat conduction element.

According to a first embodiment, it can be provided that the heat conduction element is connected to the housing in a materially-bonded, friction-locked, and/or formfitting manner or is integrally formed with the housing.

This reduces the production expenditure of a corresponding conduit connection device. If the housing consists of plastic, for example, it can be produced in the injection molding method and the heat conduction element can be extrusion coated or embedded. Further fastening options in the housing of the conduit connection device comprise, inter alia, adhesive bonding, latching, screwing, or pressing in.

If the heat conduction element is integrally formed with the housing, the required number of components can be reduced.

According to a further embodiment, it can be provided that the heat conduction element is formed by a housing section having reduced wall thickness.

The reduced wall thickness reduces the inertia of the measurement system in relation to higher wall thicknesses. This is because the reduced wall thickness permits faster heat conduction between fluid and temperature sensor, so that the latter can register temperature changes in the fluid faster than with higher wall thicknesses. Deviations between reading temperature and actual temperature are minimized in this way.

According to a further embodiment, it can be provided that an opening is formed in the housing, into which the temperature sensor is inserted, wherein the opening exposes the outer side of the heat conduction element.

In this way, the temperature sensor can be attached from the outside. Furthermore, it is possible to design the conduit connection device so that the installation can take place in multiple steps, for example firstly the establishment of a fluid-tight connection of the two conduits and then insertion of the temperature sensor into the opening or vice versa. This applies in reverse sequence for disassembly, for example for the purpose of maintenance or repair. In some refining embodiments, the temperature sensor can be exchangeable.

According to a further embodiment, it can be provided that a wall between an inner side of the conduit connection device and the opening forms the heat conduction element.

In this way, the temperature sensor can be embedded deeper in the housing, due to which a corresponding conduit connection device has a more compact construction and the temperature sensor is better protected.

According to a further embodiment, it can be provided that a thermal insulator is inserted in the housing section and/or in the opening and/or into at least one pocket arranged adjacent to the opening.

The thermal insulator can insulate the temperature sensor from the outside, so that heat losses to the surroundings are reduced. This causes an increase in measurement accuracy and reduces the inertia of the temperature sensor.

A corresponding pocket has a volume for accommodating the thermal insulator and can be embodied as a depression, groove, annular groove, or the like or can have a more complex contour.

According to an embodiment, the insulator can be a thermally insulating material, such as a foam or a fiber material, and/or can have one or more closed air chambers.

According to an embodiment, the housing section having reduced wall thickness is stabilized via a frame.

Such a frame can be attached circumferentially or formed in the housing and increase the stability of the conduit connection device. The frame can be at least partially protruding in radial direction in relation to the circumferentially adjoining areas and/or in relation to areas adjoining in axial direction. In at least one view, in particular one in the radial direction, the frame can be made rectangular, i.e. can have walls aligned at right angles to one another. Furthermore, the above-described thermal insulator can be arranged in such a frame and/or adjoining such a frame.

According to an embodiment, a ring can be provided on the conduit connection device, which at least partially covers the housing section having reduced wall thickness at least in one position.

Such a ring can be used, on the one hand, to stabilize the housing and, on the other hand, to better insulate the temperature sensor.

In an embodiment, the ring can be made axially displaceable.

An axially displaceable ring can facilitate the installation of the conduit connection device.

According to a further embodiment, it can be provided that catch projections and/or catch recesses for locking the temperature sensor are provided at the opening.

In this way, more complex measures for fastening the temperature sensor, for example screw connections, can be omitted. Screw connections cause the problem, for example, that corresponding cables on the temperature sensor have to be twisted, which causes mechanical tension on the cable and the cable connections. The temperature sensor can have a housing having corresponding catch counterparts which interact with the catches formed in the housing.

The catches can be designed so that the temperature sensor is pressed with its sensing area into the heat conduction element. Incorrect measurements, for example, due to an air gap, can be prevented in this way.

According to a further embodiment, it can be provided that the heat conduction element consists of metal, in particular aluminum or copper, or a metal alloy, in particular comprising aluminum or copper.

Aluminum, copper, and alloys which contain aluminum and/or copper to a sufficient extent are good heat conductors. They are therefore suitable for quickly registering current fluid temperatures, since they react to changes of the fluid temperatures quickly with the establishment of new equilibrium states. Furthermore, these materials may be molded and/or formed efficiently, for example, by casting, deep drawing, or hydroforming.

Thermally conductive plastics are useful as further materials from which the heat conduction element can be produced in the injection molding method.

Other factors may have to be taken into consideration in the material selection, for example other materials used in the fluid conduit system. If, for example, a copper element is provided, for example, in a heat exchanger, and the fluid is ion conducting, the galvanic voltage potential of the material has to be taken into consideration since otherwise corrosion can occur.

The material selection of the heat conduction element can be dependent on the chemical properties of the fluid flowing against the heat conduction element, in order to avoid possible chemical interactions between the fluid and the heat conduction element. Thus, for example, by providing chemically inert coatings of the heat conduction element, corrosion thereof can be prevented while simultaneously maintaining good heat conduction properties.

According to a further embodiment, it can be provided that the heat conduction element is designed as a heat conduction sleeve.

In many embodiments, this enables a completely or at least substantially rotationally symmetrical embodiment of the heat conduction sleeve, which facilitates the installation of a corresponding conduit connection device. At the same time, it is possible to reduce the risk of leaks in edge areas.

This is the case in particular if the heat conduction sleeve is formed with closed walls circumferentially according to an embodiment, since in that case a seal is only required in the vicinity of the corresponding end faces of the heat conduction sleeve. Leaks are only a concern there if the heat conduction sleeve itself consists of a fluid-tight material, which is generally the case in particular with metals.

According to a further embodiment, it can be provided that a first seal is arranged between housing and heat conduction element.

Such a seal can be embodied as a ring seal, in particular as an O-ring, which is cost-effective and can be produced easily.

According to a further embodiment, it can be provided that a holding geometry for holding a second seal is provided on the heat conduction element.

In this way, it is possible to provide a seal which is easy to install and is easily exchangeable in case of wear. The seal can be embodied as a ring seal, in particular as an O-ring.

The holding geometry can be designed according to an embodiment as a circumferential groove. The seal can be seated in such a groove without obstructing an installation of a corresponding conduit connection device.

In particular the common provision of first seal and second seal in an embodiment can be used to seal the heat conduction element, in particular the heat conduction sleeve, from both sides and thus ensure a high degree of fluid-tightness. In this way, a corresponding conduit connection device can be provided for specifications which are otherwise achievable with difficulty, for example high fluid pressures.

According to a further embodiment, it can be provided that the heat conduction element continues an internal contour of the pipe section of the housing essentially seamlessly.

In this way, it is possible to minimize the influence of the heat conduction element on the flow resistance in the connection area. If a corresponding embodiment is designed for a laminar flow of the fluid, this laminar flow can be maintained undisturbed in spite of the heat conduction element. In most cases, turbulent flow forms are present. Better heat transfer to the heat conduction element is ensured by the turbulence, since the conveyed fluid mixes better. In turbulent flows, the reduction of the flow resistance is based on other mechanisms, for example preventing separations, cross-sectional jumps, wall friction, etc.

According to a further embodiment, it can be provided that the heat conduction element is provided for contact on an outer side of the counterpart conduit element.

In such an embodiment, the heat conduction element can be a structure-providing element which partially determines or increases the stability of the conduit connection device.

According to a further embodiment, it can be provided that the heat conduction element has a clear diameter which essentially corresponds to a clear diameter of the pipe section.

This can achieve the effect that the flow resistance does not increase due to the provision of a temperature measuring device and the pressure of the fluid does not drop in the area of the temperature measuring device.

According to a further embodiment, it can be provided that the heat conduction element has a bulge constricting the clear diameter of the pipe section, wherein the bulge is formed steadily.

The flow velocity of the fluid can be locally increased by the bulge, due to which more heat convection is achieved at the bulge. Furthermore, the bulge increases the surface area, which enables a higher heat flow to the temperature sensor, due to which system inertia is reduced and measurement accuracy is increased. Furthermore, the thermal gradient is increased. Moreover, in turbulent flows, turbulence is increased, which results in better mixing of the fluid. In addition, the temperature sensor can be placed deeper in the housing. The pressure drop downstream of the bulge is minimized by the steady embodiment of the bulge.

The bulge can be integrally formed with the fluid-conducting sections of the conduit connection device and in particular can be molded into the housing.

According to a further embodiment, it can be provided that the heat conduction element has a fluid contact area against which the fluid flows directly, wherein the temperature sensor is arranged close to the fluid contact area.

“Close” should be interpreted in this context relative to the dimensions of the respective conduit connection device. Depending on the specific embodiment, it can be provided according to this refinement that the distance between fluid contact area and temperature sensor along the heat conduction element is reduced to a technically possible minimum. In some specific embodiments, the temperature sensor can be arranged radially outside the fluid contact area, i.e. in the fluid contact area of the heat conduction element directly on the opposite side from the side in fluid contact. In other specific embodiments, an axial and/or radial offset of the temperature sensor relative to the fluid contact area can be necessary because of the design. In such embodiments, according to this refinement, the distance along the heat conduction element is reduced to a technically possible minimum. In this way, the inertia of the temperature measurement can be minimized.

### BRIEF DESCRIPTION OF THE FIGURES

Further features, details, and advantages of the invention result from the wording of the claims and from the description of exemplary embodiments on the basis of the drawings that follows. In the figures:

FIG. 1 shows a three-dimensional sectional view of a connected conduit connection device according to a first embodiment;

FIG. 2 shows an enlarged longitudinal sectional view of the connected conduit connection device from FIG. 1;

FIG. 3 shows a perspective illustration of a conduit connection device according to a second embodiment;

FIG. 4 shows an enlarged longitudinal sectional view of the connected conduit connection device from FIG. 3;

FIG. 5 shows a perspective illustration of a conduit connection device according to a third embodiment;

FIG. 6 shows an enlarged longitudinal sectional view of the connected conduit connection device from FIG. 5, and

FIG. 7 shows a detail of a conduit connection device according to a fourth embodiment.

### DETAILED DESCRIPTION

In the exemplary embodiments that follow, identical or identically acting parts or components are provided with identical reference signs for better readability. To avoid repetitions in exemplary embodiments described later, reference is made to the previously described exemplary embodiments.

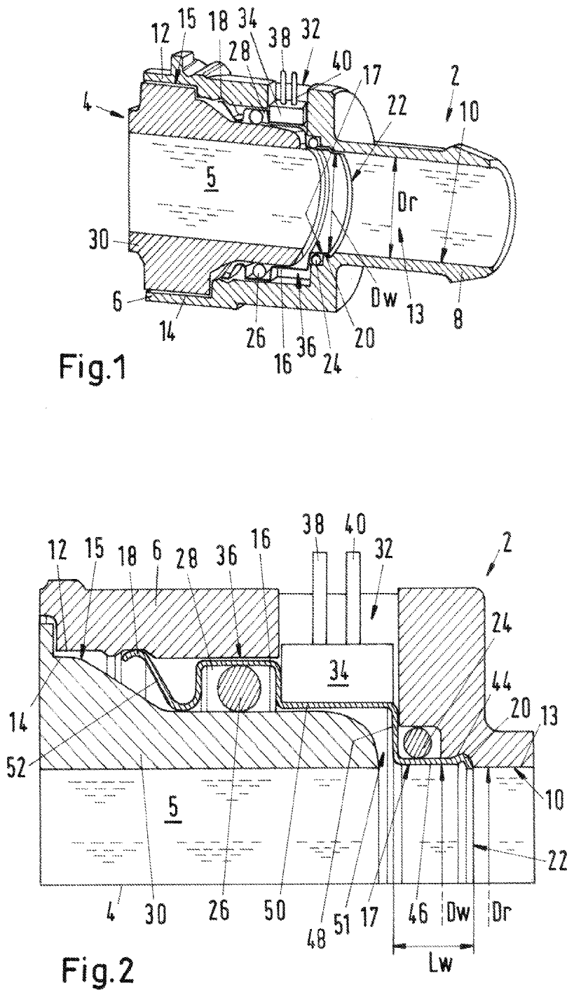

FIG. 1 shows a three-dimensional sectional view of a connected conduit connection device 2 according to a first embodiment.

The conduit connection device 2 is connected to a counterpart conduit element 4 and establishes a flow connection for a fluid 5 between a conduit (not shown in FIG. 1) arranged on the conduit connection device 2 and a conduit (not shown in FIG. 1) arranged on the counterpart conduit element 4. The conduits can in various embodiments be hoses or pipes or connecting pieces.

The conduit connection device 2 has a housing 6, on which a flange 8 is provided for fastening a hose, pipe, or connecting piece. A connection geometry 12 is formed in the housing 6 on an inner side 10. The inner side 10 defines a pipe section 13. For this purpose, a clear cross section of the inner side 10 widens toward the connection geometry 12, since in the present case the conduit connection device 2 is designed as a female connection type. Other exemplary embodiments can represent male connection types. The counterpart conduit element 4 has a corresponding counterpart connection geometry 14, which is formed on an outer side 15 of the counterpart conduit element 4.

A heat conduction sleeve 16 is arranged on the conduit connection device 2 on the inner side 10. The heat conduction sleeve 16 is arranged such that fluid 5 flowing past comes into contact directly with the heat conduction sleeve 16 on an inner side 17, so that good heat exchange can take place. The heat exchange sleeve 16 consists of a material having good heat conductivity to reduce the inertia of the system, in the present case an aluminum alloy. If the fluid 5 has a static or quasistatic temperature, the heat conduction sleeve 16 will assume essentially the same temperature as the fluid 5 within a short time. The heat conduction sleeve 16 has good external insulation by the housing 6 that very substantially surrounds it, so that external factors influencing the temperature of the heat conduction sleeve 16 are relatively weak, so that it can be assumed as an approximation that the heat conduction sleeve 16 has essentially the same temperature as the fluid 5.

In a connection area, in which the conduit connection device 2 and counterpart conduit element 4 overlap, the heat conduction sleeve 16 is arranged between conduit connection device 2 and counterpart conduit element 4.

The heat conduction sleeve 16 is latched with the housing 6 of the conduit connection device 2 by means of two flanges 18, 20 and establishes a formfitting connection between housing 6 and conduit connection device 2.

Other exemplary embodiments can provide other connection concepts of a heat conduction sleeve to a housing; for example, the heat conduction sleeve can be pressed in or, in the case of metallic housings, welded in.

A first seal 24, which prevents escape of the fluid 5 to be conducted, is provided in the vicinity of an end face 22 of the heat conduction sleeve 16.

A second seal 26 is inserted in a groove 28 formed in the heat conduction sleeve 16 and forms a seal between heat conduction sleeve 16 and a housing 30 of the counterpart conduit element 4.

A recess 32 is provided in the housing 6 of the conduit connection device 2, in which a temperature sensor 34 is inserted. The temperature sensor 34 contacts the heat conduction sleeve 16 from an outer side 36 of the conduction sleeve 16.

Due to the arrangement of the temperature sensor 34 on the outer side 36 of the heat conduction sleeve 16 facing away from the fluid, it is possible for the temperature sensor 34 to be decoupled from direct contact with the fluid 5. The leak-tightness of the conduit connection device 2 can thus be ensured, a small and cost-effective temperature sensor 34 can be used, and nonetheless accurate temperature measurements can be achieved.

The temperature sensor 34 is connected by means of two cables 38, 40 to a corresponding electronics unit which evaluates sensor data (not shown). Other exemplary embodiments can have more than two cables, for example, three or four cables.

The heat conduction sleeve 16 with its inner side 17 defines a clear diameter Dw, which essentially corresponds to a clear diameter Dr of the pipe section 13 of the housing 6. In this way, an increase in the flow resistance and an accompanying pressure drop in the fluid 5 can be prevented, which optimizes the flow efficiency of the conduit connection device 2.

FIG. 2 shows an enlarged longitudinal sectional view through the conduit connection device 2.

The heat conduction sleeve 16 is designed as a contoured and stamped deep drawn component. The inner side 17 of the heat conduction sleeve 16 continues the inner side 10 of the pipe section 13 of the housing 6 essentially seamlessly so as not to disrupt the flow of the fluid 5.

As can be seen in the exemplary embodiment, the inner side 17 of the heat conduction sleeve 16 lies slightly radially outside the inner side 10 of the pipe section 13 of the housing 6, so that the clear diameter Dw of the conduction sleeve 16 is somewhat larger than the clear diameter Dr of the pipe section 13. In other exemplary embodiments, the two diameters Dr and Dw can be equal. The end face 22 of the heat conduction sleeve 16 is embedded essentially seamlessly into the pipe section 13, in which a corresponding ring groove 44 is formed for this purpose.

The heat conduction sleeve 16 has a fluid contact area 46, against which the fluid 5 flows directly. Defined by the clear diameter Dw of the heat conduction sleeve 16 and a length Lw of the heat conduction sleeve 16, a large surface area of the heat conduction sleeve 16 in comparison to conventional temperature sensors is in heat exchange with the fluid 5, due to which the conduction sleeve 16 can react quickly to temperature differences in the fluid 5 and the temperature of the heat conduction sleeve 16 is equalized quickly to the current temperature of the fluid 5.

The heat conduction sleeve 16 widens (in the present illustration to the left). A radially aligned section 48 like a circular ring, which merges into a cylindrical section 48, adjoins the fluid contact area 46 of the heat conduction sleeve 16. The temperature sensor 34 is arranged in this cylindrical section 50 on the outer side 36. Planar contact of the temperature sensor 34 is possible due to the cylindrical contour.

The distance between the temperature sensor 34 and the fluid contact area 46 is essentially determined by the radial section 48, which is in turn determined by a thickness of the housing 30 of the counterpart conduit element 4.

Between the radial section 48 and the housing 30 of the counterpart conduit element 4, in the exemplary embodiment shown in the present case, a radially aligned slot 51 is present, around which the fluid 5 can also flow, so that the radial section 48 also contributes to temperature equalization between heat conduction sleeve 16 and fluid 5. In other exemplary embodiments, the heat conduction sleeve 16 can tightly adjoin the housing 30 of the counterpart conduit element 4.

Downstream of the radial section 48 is the groove 28 formed in the heat conduction sleeve 16 for receiving the second seal 26.

A transition area 52 between groove 28 and flange 18 has a steadily and conically widening configuration, due to which the transition area 52 is spring-elastic. The transition area 52 can thus compensate for tolerances in the housing 6 of the conduit connection device 2 and in the housing 30 of the counterpart conduit element 4 in the area of the connection geometry 12 and the counterpart connection geometry 14.

The heat conduction sleeve 16 has a complex shape in longitudinal section, which can be produced by various methods, such as hydroforming.

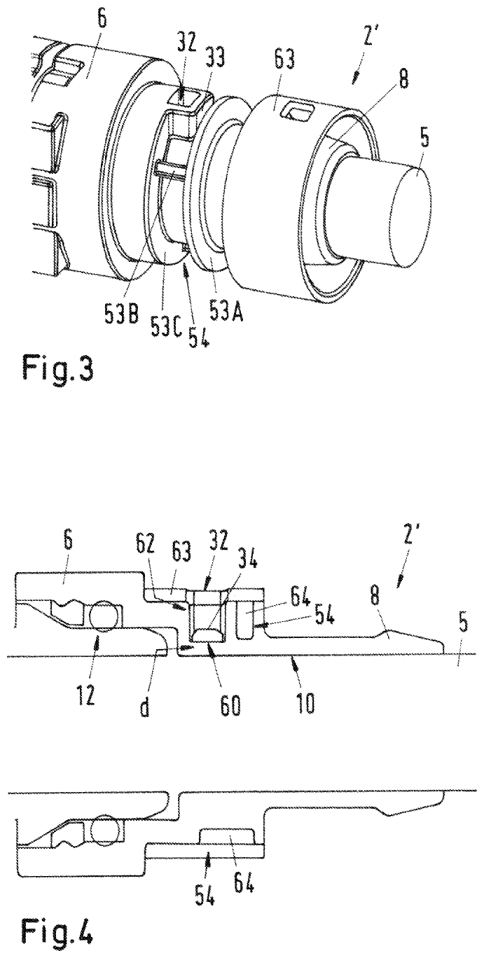

FIG. 3 shows a three-dimensional diagram of a connected conduit connection device 2′ according to a second embodiment.

The conduit connection device 2′ is provided for connection to a counterpart conduit element (not shown) and establishes a flow connection for a fluid 5 between a conduit (not shown in FIG. 3) arranged on the conduit connection device 2′ and a conduit (not shown in FIG. 3) arranged on the counterpart conduit element (not shown). The conduits can be hoses or pipes or connecting pieces in various embodiments.

The conduit connection device 2′ has a housing 6, on which a flange 8 is provided for fastening a hose, pipe, or connecting piece.

An opening 32, in which a temperature sensor is inserted, which can be seen in FIG. 4, is provided in the housing 6 of the conduit connection device 2′.

A frame 33 is formed around the opening 32 in the housing 6, which stabilizes the housing 6 in the area of the opening 32, since the resulting wall thickness of the housing 6 can be less there than in other areas of the housing 6. The frame 33 is essentially rectangular in a top view oriented in radial direction and extends radially to a wider diameter than the circumferentially adjoining areas. The frame 33 can extend radially depending on the embodiment to approximately a diameter of one of the axially adjacent areas. Depending on the embodiment, the frame 33 can have a larger radial extension overall than the flange 8, but a smaller radial extension than the connection geometry 12.

The area circumferentially adjoining the frame 33, together with adjoining contours formed in the housing 6, here a flange 53A, a land 53B, and a wall 53C, forms a circumferential pocket 54, which can be filled with a thermal insulator material (not shown in FIG. 3) or with air, as will be explained in more detail in conjunction with FIG. 4. To increase the stability, the frame 33 is extended in axial direction, which causes the flange 8 also to have a correspondingly longer axial extent than without such a frame.

An axially displaceable ring 63 arranged on the outer circumference is used, on the one hand, for the thermal decoupling of the medium located in the opening 32 and possibly the additional insulator material in the adjoining areas and thus of the temperature sensor.

On the other hand, the ring 63 can be used for additionally stabilizing the conduit connection device 2′, in that it is arranged on the outer circumference at the opening 32, as can be seen in FIG. 4. The ring 63 can consist of a stronger material than the housing 6 of the conduit connection device 2′, such as steel or a fiber composite material, and can ensure the structural stability of the conduit connection device 2′ in spite of reduced material thickness in the area of the opening 32.

FIG. 4 shows an enlarged longitudinal sectional view through the conduit connection device 2′.

A connection geometry 12 is formed in the housing 6 on an inner side 10. The conduit connection device 2′ is designed as a female connection type. Other exemplary embodiments can represent male connection types. The counterpart conduit element has a corresponding counterpart connection geometry.

The ring 63 overlaps the pocket 54 formed in the housing 6 in the position shown in FIG. 4 and substantially closes it off from the surroundings.

The pocket 54 is filled with another thermal insulator 64 and thus achieves better thermal decoupling of the temperature sensor 34 from the surroundings. The thermal insulator 64 can be air in some specific embodiments, in other specific embodiments a thermally insulating solid more suitable for the environmental conditions, such as a fiber material or foam.

A temperature sensor 34 is arranged on a bottom 60 of the opening 32. Due to the arrangement of the temperature sensor 34 in the opening 32, it is firstly possible to achieve the effect that the temperature sensor 34 is decoupled from direct contact with the fluid 5. Leak-tightness of the conduit connection device 2′ can thus be ensured, a small and cost-effective temperature sensor 34 can be used, and nonetheless accurate temperature measurements can be achieved. Secondly, faster temperature equalization between fluid and temperature sensor 34 can be achieved, because a wall thickness d of a housing section 62 there is reduced in the opening 32, so that changes in temperature of the fluid 5 can be conducted faster to the temperature sensor 34.

For better thermal coupling, the temperature sensor 34 can be arranged in the opening 32 using a heat conduction paste (not shown), which ensures full surface contact of the temperature sensor 34 with the bottom 60.

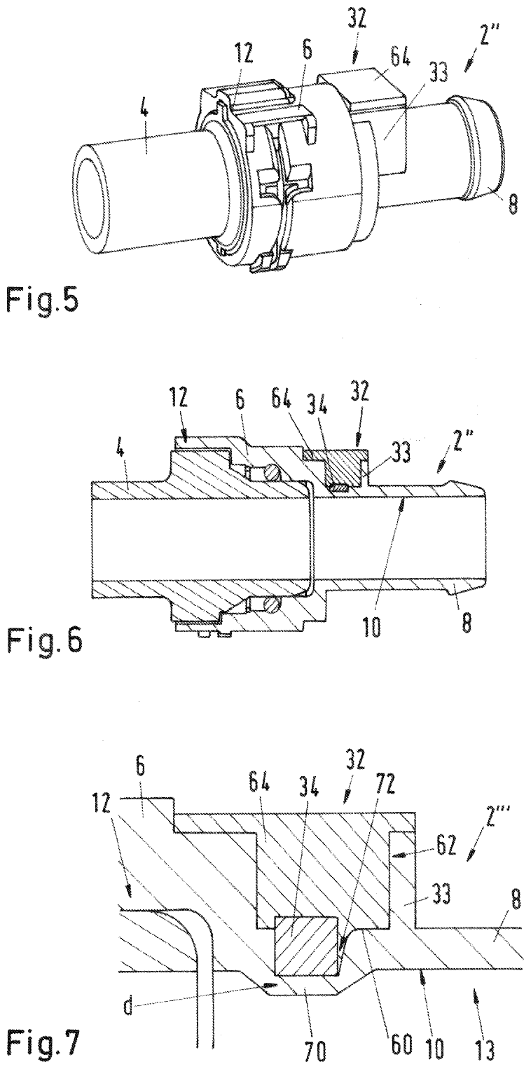

FIG. 5 shows a three-dimensional view of a connected conduit connection device 2″ according to a third embodiment.

The conduit connection device 2″ is provided for connection to a counterpart conduit element 4 and establishes a flow connection for a fluid between a conduit (not shown in FIG. 5) arranged on the conduit connection device 2″ and a conduit (not shown in FIG. 5) arranged on the counterpart conduit element 4. The conduits can be hoses or pipes or connecting pieces in various embodiments.

The conduit connection device 2″ has a housing 6, on which a flange 8 is provided for fastening a hose, pipe, or connecting piece.

An opening 32 is provided in the housing 6 of the conduit connection device 2″, in which a temperature sensor is inserted, which can be seen in FIG. 6. Due to the arrangement of the temperature sensor in the opening 32, the temperature sensor can be decoupled from direct contact with the fluid. The leak-tightness of the conduit connection device 2″ can thus be ensured, a small and cost-effective temperature sensor 34 can be used, and nonetheless accurate temperature measurements can be achieved.

A frame 33 is formed around the opening 32 in the housing 6, which stabilizes the housing 6 in the area of the opening 32, since the resulting wall thickness of the housing 6 can be less there than in other areas of the housing 6. The frame 33 extends radially to a wider diameter than the circumferentially adjoining areas. Depending on the embodiment, the frame 33 can extend radially to approximately a diameter of one of the axially adjacent areas. Depending on the configuration, the frame 33 can overall have a larger radial extension than the flange 8, but a smaller radial extension than the connection geometry 12.

The opening 32 is covered by a thermal insulator 64, which improves the thermal properties and increases the measurement accuracy of the temperature sensor.

FIG. 6 shows a longitudinal sectional view through the conduit connection device 2″.

In the housing 6, a connection geometry 12 for connecting the counterpart conduit element 4 is formed on an inner side 10. The conduit connection device 2″ is designed as a female connection type. Other exemplary embodiments can represent male connection types. The counterpart conduit element 4 has a corresponding counterpart connection geometry.

FIG. 7 shows a detail of a conduit connection device 2″′ according to a fourth embodiment.

On the inner side 10 of the conduit connection device 2″′, as can be seen in FIG. 7, a bulge 70 is formed, which reduces a clear diameter of the pipe section 13. The local reduction of the clear diameter of the pipe section 13 in the area of the bulge 70 causes an increase of the flow velocity of the fluid and thus better heat convection in this area. The bulge 70 moreover increases the heat transfer due to a larger surface than a flat embodiment, an increased thermal gradient, and better mixing of the fluid due to stronger turbulence. The bulge 70 is formed steadily in a manner optimized for fluid dynamics in order to minimize a downstream pressure drop due to the bulge 70.

The bulge 70 is molded into the housing 6, i.e. formed from the material of the housing 6.

A temperature sensor 34 is arranged on a bottom 60 of the opening 32 in a recess 72. The recess 72 is formed on the inner side of the bulge 70. The recess 72 reduces the wall thickness d in the area of the bulge 70, which optimizes the heat conduction to the temperature sensor 34.

Due to the arrangement of the temperature sensor 34 in the recess 72, it is firstly possible to achieve that effect that the temperature sensor 34 is decoupled from direct contact with the fluid. Leak-tightness of the conduit connection device 2″′ can thus be ensured, a small and cost-effective temperature sensor 34 can be used, and nonetheless accurate temperature measurements can be achieved.

An insulator 64, which prevents dissipation of heat to the surroundings and thus increases the measurement accuracy of the temperature sensor 34, is arranged radially outside the temperature sensor 34.

The invention is not restricted to the above-described embodiments, but rather can be modified in a variety of ways.

All features and advantages that are apparent from the claims, the description, and the drawings, including construction details, spatial arrangements, and method steps, may be essential to the invention both as such and in a wide variety of different combinations.

As used herein, the terms “general,” “generally,” and “approximately” are intended to account for the inherent degree of variance and imprecision that is often attributed to, and often accompanies, any design and manufacturing process, including engineering tolerances, and without deviation from the relevant functionality and intended outcome, such that mathematical precision and exactitude is not implied and, in some instances, is not possible.

All the features and advantages, including structural details, spatial arrangements and method steps, which follow from the claims, the description and the drawing can be fundamental to the invention both on their own and in different combinations. It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCE NUMERALS

2, 2′, 2″, 2″′ conduit connection device
4 counterpart conduit element
5 fluid
6 housing
8 flange
10 inner side
12 connection geometry
13 pipe section
14 counterpart connection geometry
15 outer side
16 heat conduction sleeve
17 inner side
18 flange
20 flange
22 end face
24 first seal
26 second seal
28 groove
30 housing
32 opening
33 frame
34 temperature sensor
36 outer side
38 cable
40 cable
44 annular groove
46 fluid contact area
48 radial section
50 cylindrical section
51 slot
52 transition area
53A flange
53B land
53C wall
54 pocket
60 bottom
62 housing section
63 ring
64 insulator
70 bulge
72 recess
d wall thickness
Dr clear diameter of pipe section
Dw clear diameter of heat conduction sleeve
Lw length of contact area of heat conduction sleeve

1. A conduit connection device, comprising a housing, which has a connection geometry for connection of a conduit element which is connected to the conduit connection device to a counterpart conduit element, a hollow pipe section for transporting a fluid through the conduit connection device, and a temperature sensor for measuring a temperature of the fluid to be conducted through the conduit connection device, wherein a heat conduction element is arranged in the housing such that the fluid to be transported flows against it on an inner side of the heat conduction element, wherein the temperature sensor is arranged on an outer side of the heat conduction element.

2. The conduit connection device as claimed in claim 1, wherein the heat conduction element is connected to the housing in a materially-bonded, friction-locked, and/or formfitting manner or is integrally formed with the housing.

3. The conduit connection device as claimed in claim 1, wherein the heat conduction element is formed by a housing section having reduced wall thickness.

4. The conduit connection device as claimed in claim 1, wherein an opening is formed in the housing, into which the temperature sensor is inserted, wherein the opening exposes the outer side of the heat conduction element.

5. The conduit connection device as claimed in claim 4, wherein a wall between an inner side of the conduit connection device and the opening forms the heat conduction element.

6. The conduit connection device as claimed in claim 3, wherein a thermal insulator is inserted into the housing section and/or into the opening and/or into at least one pocket arranged adjacent to the opening.

7. The conduit connection device as claimed in claim 3, wherein the housing section having reduced wall thickness is stabilized by means of via a frame.

8. The conduit connection device as claimed in claim 4, wherein catch projections and/or catch recesses for locking the temperature sensor are provided at the opening.

9. The conduit connection device as claimed in claim 1, wherein the heat conduction element consists of aluminum or copper, or a metal alloy comprising aluminum or copper.

10. The conduit connection device as claimed in claim 1, wherein the heat conduction element is designed as a heat conduction sleeve.

11. The conduit connection device as claimed in claim 1, wherein a first seal is arranged between housing and heat conduction element.

12. The conduit connection device as claimed in claim 1, wherein a holding geometry for holding a second seal is provided on the heat conduction element.

13. The conduit connection device as claimed in claim 1, wherein the heat conduction element essentially continuously continues on inner contour of the pipe section of the housing.

14. The conduit connection device as claimed in claim 1, wherein the heat conduction element is provided for contact on an outer side of the counterpart conduit element.

15. The conduit connection device as claimed in claim 1, wherein the heat conduction element has a clear diameter which corresponds to a clear diameter of the pipe section.

16. The conduit connection device as claimed in claim 1, wherein the heat conduction element has a bulge constricting the clear diameter of the pipe section, wherein the bulge is formed steadily.

17. The conduit connection device as claimed in claim 1, wherein the heat conduction element has a fluid contact area, against which the fluid flows directly, wherein the temperature sensor is arranged close to the fluid contact area.
